(19) United States
(12) Patent Application Publication
(10) Pub. No.: US 2015/0266107 A1
(43) Pub. Date: Sep. 24, 2015

(54) Drill and Drill Head with Drill Margin

(71) Applicant: Iscar, Ltd., Tefen (IL)

(72) Inventors: Eitan Gonen, Kfar Vradim (IL); Anatoly Yanovski, Maalot (IL)

(73) Assignee: Iscar, Ltd., Tefen (IL)

(21) Appl. No.: 14/219,893

(22) Filed: Mar. 19, 2014

(51) Int. Cl. B23B 51/02

(52) U.S. Cl. CPC B23B 51/02; B23B 2228/28; B23B 2251/408; B23B 2251/446

(57) ABSTRACT

A drill or drill head with a drill margin which comprises a margin extremity adjacent to a relief surface. The margin extremity is located outside of the cutting diameter.

### FIELD OF THE INVENTION

The subject matter of the present application relates to drill margins, in particular drill margins of drills and drill heads configured for drilling ductile materials such as low carbon steel and alloy steel.

### BACKGROUND OF THE INVENTION

One measurement of drilling quality is the finish provided to workpiece. Providing a high-quality finish on ductile materials, such as low carbon steel or alloy steel, can be particularly challenging, and improved finish is often a desired result.

U.S. Pat. No. 8,419,322 discloses tool for use in a preformed round hole. More precisely it discloses a cutting insert with a minor edge cutting flank adjoining a minor cutting edge against a direction of rotation, and comprising a support element arranged at a distance from the major cutting edge against a feed direction. The support element has a radius of revolution larger than a pitch circle radius of the cutting insert, during a drilling operation. The support element is mentioned as being able to provide both a supporting function and a smoothing function.

### SUMMARY OF THE INVENTION

The subject matter of the present application is applicable to drills and drill heads configured for creating and/or deepening preformed holes. Notably, drills of the present application are configured for only axially machining (i.e. drilling) and are not configured for machining in a non-axial direction (e.g. shouldering, ramping). More specifically, drills according to the present application are configured only for drilling holes of diameter corresponding to a cutting diameter of the tool. Nonetheless, the term “drill” is inclusive of drills configured to rotate and static drills configured to be static while a work piece is rotated.

In accordance with a first aspect of the subject matter of the present application, there is provided a drill or drill head having a central axis A_{C} defining a front-to-rear direction and comprising:
a plurality of cutting portions;
each cutting portion comprising:
   a rake surface;
   a relief surface;
   a cutting edge formed at an intersection of the rake and relief surfaces and extending rearwardly to a cutting edge extremity defining a cutting diameter of the drill; and
   a margin extending rearwardly from the relief surface and also extending from the rake surface;
wherein each margin comprises a margin extremity adjacent to the relief surface and located outside of the cutting diameter.

The margin, and more particularly the margin extremity, has been found to provide a burnishing function, and test results received thus far have surprisingly found that longevity of a drill or drill head with such margin extremity is apparently increased over comparative tools.

It will be understood that a drill or drill head with the above geometry, prior to the present discovery, was expected to shatter upon compression in a hole being drilled. It was theorized and testing has surprisingly confirmed that at least when drilling low carbon steel or alloy steel (believed to be due to the ductility thereof) such geometry is not adversely affected.

In accordance with another aspect of the subject matter of the present application, there is provided a drill or drill head comprising a cutting portion; the cutting portion comprising a drill margin; the drill margin comprising a margin extremity adjacent to a relief surface and located outside of a cutting diameter.

It will be understood that the above is a summary, and that any of the aspects above may further comprise any of the features described hereinbelow. Specifically, the following features, either alone or in combination, may be applicable to any of the above aspects:

A. A drill or drill head can have a central axis A_{C} defining a front-to-rear direction. A drill or drill head can by rotationally symmetric about the central axis A_{C}. Cutting edge extremities of a drill or drill head can be equally circumferentially spaced about the central axis A_{C}. Margins of a drill or drill head can be equally circumferentially spaced about the central axis A_{C}.

B. A drill or drill head can comprise a plurality of cutting portions.

C. A cutting portion can comprise a rake surface, a relief surface, and a cutting edge formed at an intersection of the rake and relief surfaces.

D. A cutting edge can extend rearwardly to a cutting edge extremity defining a cutting diameter of the drill or drill head. A cutting edge can be configured for drilling ductile materials such as low carbon steel and alloy steel. A cutting edge can have a rake angle Θ, at a cutting edge extremity, of twenty to thirty degrees (20°≦Θ≦30°).

E. A cutting portion can comprise a margin extending rearwardly from a relief surface and also extending from a rake surface.

F. A margin can comprise a margin extremity adjacent to a relief surface and located outside of the cutting diameter. Stated differently, a margin extremity is located further from a central axis A_{C} than a cutting edge extremity. Stated differently yet, a margin extremity constitutes a furthermost point from the central axis A_{C}.

G. A margin can extend outside of a cutting diameter beginning from a cutting edge extremity. A margin can extend outside of the cutting diameter beginning from the cutting edge extremity, and continuously increase distance from the cutting diameter until a margin extremity. The continuous increase in distance can be at a decreasing rate (i.e. having a convexly-curved shape in a top view thereof).

H. A cutting portion can comprise a margin edge extending along an intersection of a margin and a rake surface. A margin, at each axial location along the margin edge, can comprise an extremity extending outside of a cutting diameter. A margin, at each axial location along the margin edge, can extend outside of the cutting diameter beginning from the margin edge. A margin, at each axial location along the margin edge, can continuously increase distance from the cutting diameter until an extremity. The continuous increase in distance can be at a decreasing rate (i.e. having a convexly-curved shape in a top view thereof).

I. A margin extremity can extend outside of a cutting diameter by a protrusion distance D_{P} of at least one micron (0.001 mm). Thus far, successful results have been achieved with protrusion distances D_{P} less than 5 microns (0.005 mm). A margin extremity can preferably extend outside of a cutting diameter by a protrusion distance D_{P} of one to five microns (0.001 mm≦D_{P}≦0.005 mm). A margin, at each axial location, can comprise an extremity extending outside of the cutting diameter by a protrusion distance D_{P} corresponding to the values above mentioned in connection with the margin extremity.

J. An entire margin can be located outside of the cutting diameter.

K. A margin can extend an axial distance no greater than 0.1 mm from a relief surface, preferably no greater than 0.01 mm from the relief surface.

L. A margin can comprise a margin portion. The margin portion can be the only portion of the margin comprising an extremity located outside of the cutting diameter. The margin portion can extend an axial distance no greater than 0.1 mm from a relief surface, preferably no greater than 0.01 mm from the relief surface.

M. Each cutting portion or margin of a drill or drill head (i.e. all cutting portions or all margins) can have one or more of the features detailed above.

N. A margin width W_{M} measured from the cutting edge extremity 24 to the flank surface 42 can be between 5% to 10% of the cutting diameter D_{C} (0.05 D_{C}≦W_{M}≦0.10 D_{C}). With a range of 6%±1% having been successfully tested.

### BRIEF DESCRIPTION OF THE DRAWINGS

For a better understanding of the subject matter of the present application, and to show how the same may be carried out in practice, reference will now be made to the accompanying drawings, in which:

FIG. 1A is a side view of a drill in accordance with an embodiment of the subject matter of the present application;

FIG. 1B is a front end view or top view of the drill in FIG. 1A;

FIG. 2A is a perspective side view of a drill head of the drill in FIGS. 1A and 1B;

FIG. 2B is a first side view of the drill head in FIG. 2A;

FIG. 2C is a second side view of the drill head in FIG. 2A, rotated 90° from the view shown in FIG. 2B;

FIG. 3 is an enlarged view of the encircled portion of the drill head in FIG. 2C;

FIG. 4 is a front end view or top view of the drill head shown in FIG. 2A;

FIG. 5A is a schematic view of a prior art design, which could be found in a region of a prior art tool corresponding to the region encircled in FIG. 4;

FIG. 5B is a schematic view of another prior art design, which could be found in a region of a prior art tool corresponding to the region encircled in FIG. 4; and

FIG. 5C is a schematic view of the region encircled in FIG. 4.

### DETAILED DESCRIPTION

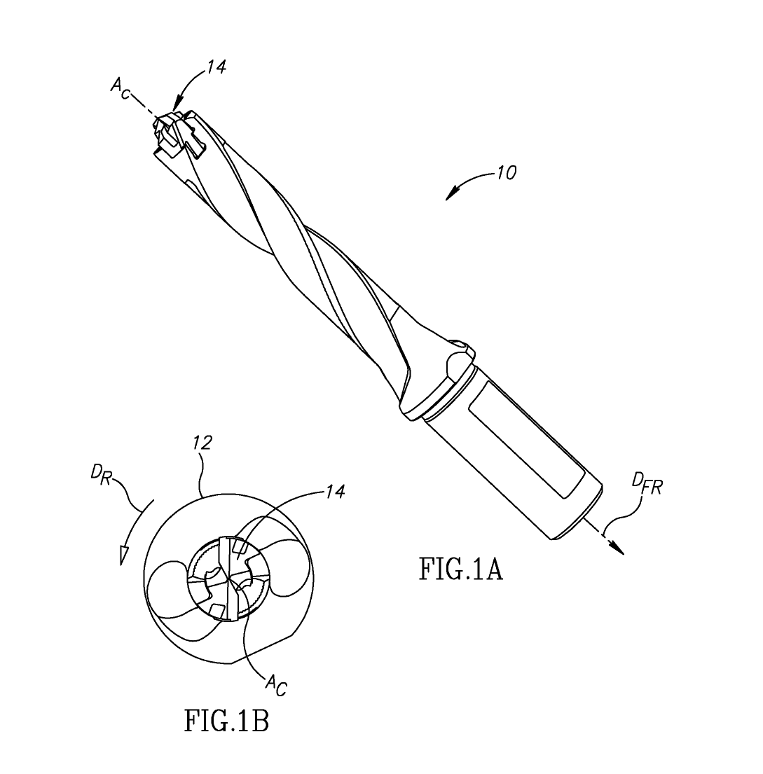

Reference is made to FIGS. 1A and 1B, illustrating a drill 10 according to the subject matter of the present application.

The drill 10 can comprise a drill body 12 and a drill head 14 configured to be mounted to the drill body 12.

The drill 10 is for metal cutting operations and the drill head 14 is typically made of extremely hard and wear-resistant material such as cemented carbide, either by form-pressing and then sintering carbide powders in a binder or by powder injection molding methods.

A central axis A_{C}, about which the drill 10 is configured to rotate in a rotation direction D_{R}, extends through the center of the drill body 12 and drill head 14 and can define a front-to-rear direction D_{FR}.

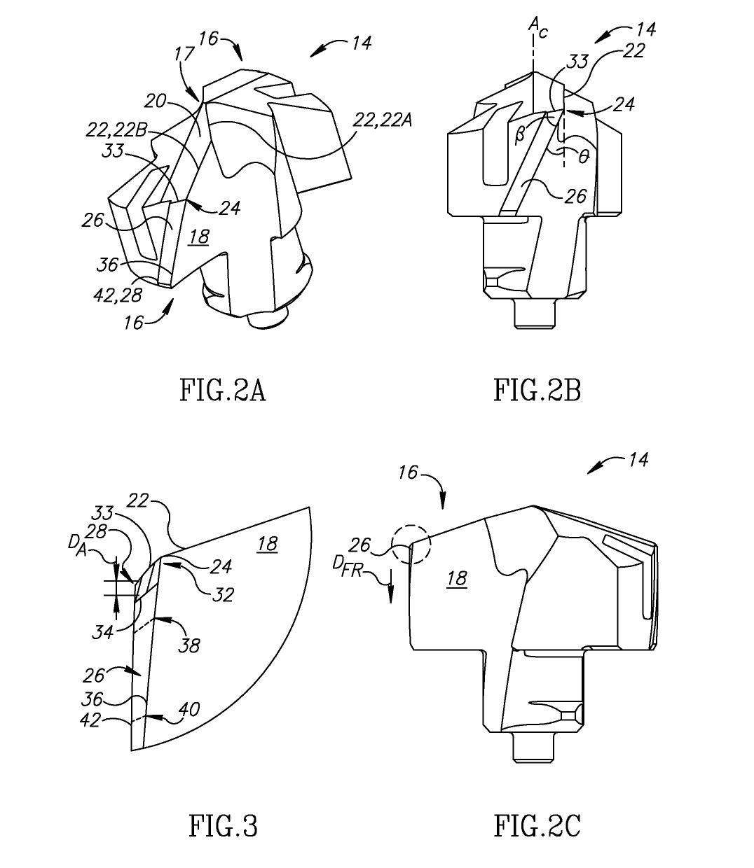

Referring now to FIGS. 2A to 2C, the drill head 14 comprises a plurality of cutting portions 16 located rearward of a chisel 17 of the drill head 14.

Each cutting portion 16 comprises a rake surface 18, a relief surface 20 and a cutting edge 22 formed at an intersection of the rake and relief surfaces 18, 20.

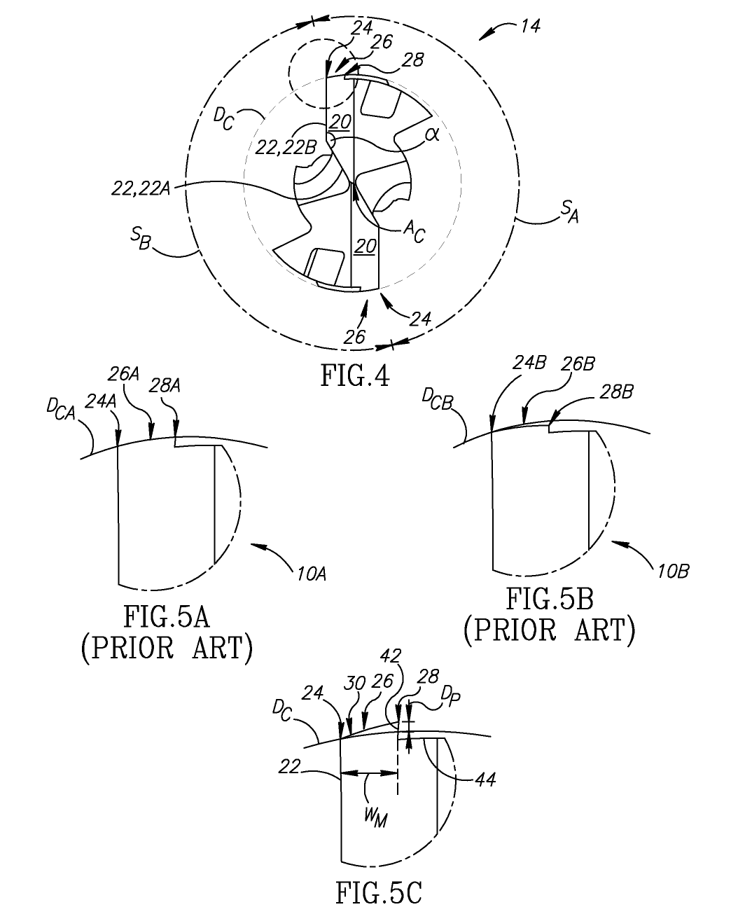

Referring also to FIG. 4, the cutting edge 22 can extend rearwardly from the chisel 17 to a cutting edge extremity 24 which defines a cutting diameter D_{C}. It will be understood from the drawings that use of the words “rearward” or “rearwardly” is not to be construed as strictly parallel with central axis A_{C} in the front-to-rear direction D_{FR}.

The rake surface 16 is configured for chips (not shown) from a workpiece (not shown) to flow thereover.

In FIG. 2B a rake angle Θ is shown, schematically, at the cutting edge extremity 24.

The relief surface 18 can form an internal acute angle β, shown schematically, with the rake surface 16 to provide relief during drilling.

In this non-limiting example, the cutting edge 22 can comprise two cutting edge portions. For example the cutting edge 22 can comprise a minor cutting edge portion 22A extending rearwardly from the chisel 17, and a major cutting edge portion 22B extending from the minor cutting edge portion 22A to the cutting edge extremity 24. The minor cutting edge portion 22A is also shown to extend radially, whereas the major cutting edge portion 22B can form an internal obtuse angle a therewith. In any case, the minor cutting edge portions 22A are preferably one third to one quarter of the length of the major cutting edges 22B.

The drill head 14 comprises a plurality of margins 26. The margins 26 are identical (as are the cutting portions 16) and therefore further reference will only be made to one of the margins 26.

Regarding rotational symmetry, with specific reference to FIG. 4, it is noted that each cutting edge extremity 24 and/or each margin 26 of the drill head are equally circumferentially spaced (S_{A}=S_{B}) about the central axis A_{C}, for reducing an imbalance of forces when the margins 26 abut an inner surface of a hole (not shown).

Referring also to FIGS. 4 and 5C, the margin 26, at least adjacent to the relief surface 20, comprises a margin extremity 28 located outside of the cutting diameter D_{C} which constitutes a furthermost point of the margin 26 from the central axis A_{C}.

Drawing attention to FIGS. 5A and 5B, prior art constructions are shown for aiding understanding of the subject matter of the present application. Each prior art drill 10A, 10B comprises a cutting diameter D_{CA}, D_{CB}, a cutting edge extremity 24A, 24B, a margin 26A, 26B and a margin extremity 28A, 28B. The prior art drill 10A in FIG. 5A is designed for the margin 26A thereof to extend along the cutting diameter D_{CA}, and consequently the margin extremity 28A thereof also coincides with the cutting diameter D_{CA}. The prior art drill 10B in FIG. 5B is designed for the margin 26B thereof to extend within the cutting diameter D_{CB}, and consequently the margin extremity 28B thereof is located within the cutting diameter D_{CB}.

Referring only to FIG. 5C, the margin 26 can extend outside of the cutting diameter D_{C} from beginning from a cutting edge extremity 24. To elaborate, at a point (schematically shown by the reference numeral “30”) which is adjacent to the cutting extremity 24, the margin is already outside of the cutting diameter D_{C}.

The margin 26, particularly the margin extremity 28, can extend a protrusion distance D_{P} of one to five microns (0.001 mm≦D_{P}≦0.005 mm) outside of the cutting diameter D_{C}.

The margin 26 can have a convexly-curved shape (i.e. it continuously extends outside of the cutting diameter D_{C} at a decreasing rate).

The margin extremity 28 can be located in a margin portion 32 of the margin 26.

Referring now to FIG. 3, the margin portion 32 extends between an upper limit 33 at an intersection of the relief surface 20 and the margin 26, to an imaginary lower limit 34 (generally located at an axial distance D_{A} of 0.01 mm to 0.1 mm from the relief surface 20, or more precisely from the upper limit 33). It will be understood that due to the receding nature of the margin 26, as perhaps understood best from FIGS. 2C and 3, engagement of the drill head 14 and a hole being drilled (not shown) is only configured to extend to the imaginary lower limit 34. Stated differently, the margin portion 32 can be the only portion of the margin 26 configured to contact a hole (not shown), however it will be understood that due to tolerances additional portions of the margin 26 may contact the hole.

Accordingly, it will be understood that while the example shown has a preferred geometry, the entire margin 26 could be constituted entirely by the area shown as the margin portion 32. In such case, the cutting portion 16 could extend radially inwardly at axial positions lower than the margin portion 32 (not shown).

In any case, the margin 26 comprises a margin edge 36 extending along an intersection of the margin 26 and the rake surface 18. The margin 26, as shown in FIGS. 2C and 3, can be formed with a receding geometry.

At each cross section taken at axial positions which are not adjacent to the relief surface 20 (i.e. axially spaced from the relief surface 20; random axial positions are taken at the positions designated as 38 and 40 for exemplary purposes only) the margin 26 has a similar shape to the shape the margin portion 32, and as shown in FIGS. 3 and 5C.

The margin 26 extends from the margin edge 36 to the margin extremity 28. The margin extremity 28 can be located at an intersection of a flank surface 42 and the margin 26.

A margin width W_{M} measured from the cutting edge extremity 24 to the flank surface 42 can be between 5% to 10% of the cutting diameter D_{C} (0.05 D_{C}≦W_{M}≦0.10 D_{C}).

The flank surface 42 can extend inward to the drill head 14. In any case, as shown in FIG. 5C, the flank surface 42 extends from a position outside of the cutting diameter D_{C} to a position within the cutting diameter D_{C}. Stated differently, the flank surface 42 is configured to provide a relief function (i.e. and can be considered a relief surface).

An outer diameter relief surface 44 can peripherally extend from the flank surface 42, in a direction away from the cutting edge extremity 24. The outer diameter relief surface 44 can be entirely located within the cutting diameter D_{C}.

The description above includes an exemplary embodiment and details, and does not exclude non-exemplified embodiments and details from the claim scope of the present application.

What is claimed is:

1. A drill having a central axis A_{C} defining a front-to-rear direction and comprising:
a plurality of cutting portions;
each cutting portion comprising:
a rake surface;
a relief surface;
a cutting edge formed at an intersection of the rake and relief surfaces and extending rearwardly to a cutting edge extremity defining a cutting diameter of the drill; and
a margin extending rearwardly from the relief surface and also extending from the rake surface;
wherein each margin comprises a margin extremity adjacent to the relief surface and located outside of the cutting diameter.

2. The drill according to claim 1, wherein each margin extends outside of the cutting diameter beginning from the cutting edge extremity.

3. The drill according to claim 2, wherein the cutting portion further comprises a margin edge extending along an intersection of each margin and the rake surface, and each margin, at each axial location along the margin edge, extends outside of the cutting diameter beginning from the margin edge.

4. The drill according to claim 2, wherein each margin extends outside of the cutting diameter beginning from the cutting edge extremity, and continuously increases distance from the cutting diameter until the margin extremity.

5. The drill according to claim 4, wherein the continuous increase in distance is at a decreasing rate.

6. The drill according to claim 4, wherein a margin edge extends along an intersection of each margin and the rake surface, and each margin, at each axial location along the margin edge, continuously increases distance from the cutting diameter until the margin extremity.

7. The drill according to claim 6, wherein the continuous increase in distance is at a decreasing rate.

8. The drill according to claim 1, wherein each margin extremity extends outside of the cutting diameter by a protrusion distance D_{P} of one to five microns (0.001 mm≦D_{P}≦0.005 mm).

9. The drill according to claim 8, wherein each margin, at each axial location, extends outside of the cutting diameter by a protrusion distance D_{P} of one to five microns (0.001 mm≦D_{P}≦0.005 mm).

10. The drill according to claim 1, wherein each margin extends an axial distance no greater than 0.1 mm from the relief surface.

11. The drill according to claim 10, wherein each margin extends an axial distance no greater than 0.01 mm from the relief surface.

12. The drill according to claim 1, wherein each margin comprises a margin portion which is the only portion of the margin comprising an extremity located outside of the cutting diameter, the margin portion extending an axial distance no greater than 0.1 mm from the relief surface.

13. The drill according to claim 12, wherein the margin portion extends an axial distance no greater than 0.01 mm from the relief surface.

14. The drill according to claim 1, wherein each cutting edge extremity is equally circumferentially spaced about the central axis A_{C}.

15. A drill head comprising a central axis A_{C} defining a front-to-rear direction and comprising a plurality of cutting portions;
each cutting portion comprising:
a rake surface;
a relief surface;
a cutting edge formed at an intersection of the rake and relief surfaces and extending rearwardly to a cutting edge extremity defining a cutting diameter of the drill; and
a margin extending rearwardly from the relief surface and also extending from the rake surface;
wherein each margin comprises a margin extremity adjacent to the relief surface and located outside of the cutting diameter.

16. The drill head according to claim 15, wherein each margin extends outside of the cutting diameter beginning from the cutting edge extremity.

17. The drill head according to claim 15, wherein each margin extends outside of the cutting diameter beginning from the cutting edge extremity, and continuously increases distance from the cutting diameter until the margin extremity.

18. The drill head according to claim 15, wherein each margin extremity extends outside of the cutting diameter by a protrusion distance D_{P} of one to five microns (0.001 mm≦D_{P}≦0.005 mm).

19. The drill head according to claim 18, wherein each margin, at each axial location, extends outside of the cutting diameter by a protrusion distance D_{P} of one to five microns (0.001 mm≦D_{P}≦0.005 mm).

20. The drill head according to claim 15, wherein each cutting edge extremity is equally circumferentially spaced about the central axis A_{C}.
